(19) United States
(12) Patent Application Publication
(10) Pub. No.: US 2026/0227310 A1
(43) Pub. Date: Aug. 6, 2026

(54) GRAIN LOSS DYNAMIC THRESHOLD GENERATION

(71) Applicant: Deere & Company, Moline, IL (US)

(72) Inventor: Federico PARDINA-MALBRAN, Fort Collins, CO (US)

(21) Appl. No.: 19/047,286

(22) Filed: Feb. 6, 2025

(51) Int. Cl. G01N 15/1031; A01D 41/127; G01N 15/10

(52) U.S. Cl. CPC G01N 15/1031; A01D 41/127; G01N 2015/1024

(57) ABSTRACT

An agricultural impact sensor senses grain strikes over a sample time and generates a sensor signal based upon the sensed grain strikes. A trend corresponding to the sensor signal is computed and an absolute difference of the sensor signal values relative to the trend is generated to obtain a set of absolute difference values. The absolute difference values are sorted, and an inflection point in the sorted absolute difference values is identified. A threshold value is generated based upon the inflection point. The agricultural impact sensor is configured to detect grain strikes using the threshold value.

### FILED OF THE DESCRIPTION

The present description relates to agricultural sensing. More specifically, the present description relates to dynamically setting a threshold for an agricultural impact sensor.

### BACKGROUND

There are a wide variety of different types of harvesting machines that harvest crops. Some such machines include crop sensors that attempt to sense crop characteristics. Crop sensors can sense crop loss, crop yield, etc.

A crop sensor may be an impact sensor that generates a sensor signal that is indicative of impacts of grain on the impact sensor. For instance, some current agricultural operations use combine harvesters to harvest grain. It is common for combine harvesters to include loss sensors that sense some type of metric that can be indicative of the amount of the harvested crop being lost during the harvesting operation. The loss sensors can include a set of impact sensors that monitor the amount of grain loss from various parts of the combine. The impact sensors can include, for instance, a set of shoe loss sensors that sense grain loss from the cleaning shoe. The sensors can also include a set of separator loss sensors that sense loss from the separator. Such impact sensors (also referred to as strike sensors) can be used to count grain strikes per unit of time (or per unit of distance travelled or on another basis) to provide an indication of the amount of grain lost.

It is also common for combines to include a yield sensor that senses some type of metric that can be indicative of the yield, such as the amount of crop harvested (e.g., bushels) per unit of area (e.g., per acre). The yield sensor can also be implemented as an impact sensor mounted in the flow of grain through the harvester, such as where grain enters a clean grain tank on the harvester, or elsewhere.

The discussion above is merely provided for general background information and is not intended to be used as an aid in determining the scope of the claimed subject matter.

### SUMMARY

An agricultural impact sensor senses grain strikes over a sample time and generates a sensor signal based upon the sensed grain strikes. A trend corresponding to the sensor signal is computed and an absolute difference of the sensor signal values relative to the trend is generated to obtain a set of absolute difference values. The absolute difference values are sorted, and an inflection point in the sorted absolute difference values is identified. A threshold value is generated based upon the inflection point. The agricultural impact sensor is configured to detect grain strikes using the threshold value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial block diagram of an agricultural harvester

FIG. 2 is a block diagram of one example of an agricultural sensing architecture.

FIGS. 3A and 3B (collectively referred to herein as FIG. 3) show a flow diagram illustrating one example of the operation of the agricultural sensing architecture and generating a threshold value for an impact sensor.

FIG. 4A is a graphical illustration depicting trend in a set of sensor signals.

FIG. 4B is a graphical illustration showing a set of absolute difference values.

FIG. 4C shows the absolute difference values sorted in ascending order and illustrating an inflection point for each sensor.

FIG. 4D is a graphical illustration showing peak identification using threshold values generated based upon the inflection points shown in FIG. 4C.

FIG. 4E shows grain strikes identified on a set of raw sensor signals using the threshold values identified based upon the inflection points.

FIG. 5 is a block diagram of one example of an agricultural sensing architecture in a remote server environment.

FIGS. 6-8 show examples of mobile devices that can be used in the architectures shown in the previous figures.

FIG. 9 is a block diagram of one example of a computing environment that can be deployed in any of the architectures shown in previous figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, many harvesters have impact sensors that sense grain strikes to detect grain loss, yield, or other metrics. Such impact sensors receive impacts from grain or other material and generate a sensor signal indicative of a voltage responsive to those impacts. Thus, the sensor signal may have peaks corresponding to grain strikes. The peaks are compared to a threshold value to determine whether they correspond to a grain strike or whether they correspond to noise or some other non-grain strike event.

The performance of such impact sensors may vary from one sensor to the next. For instance, a newer sensor, or a first kind of sensor, may be more sensitive to impacts than an older sensor or than a different kind of sensor. Sensor performance may also be affected by a variety of different criteria, such as environmental criteria, crop criteria, terrain criteria or other criteria. By way of example, the threshold value for an impact sensor may be optimally set at a first level for a first crop type, such as corn, and at a second level for a second crop type, such as wheat. Even where the crop type is the same, the threshold value may be desirably set to a different value based upon crop characteristics, such as crop moisture, or based upon terrain characteristics, such as the orientation of the harvester (e.g., whether the harvester is traveling uphill, downhill, across a sidehill, etc.). Also, the threshold value for sensors in different locations can be different. For instance, an impact sensor that senses loss from the separator may have a different desirable threshold value than on impact sensor that senses loss from the cleaning subsystem. In addition, the threshold value for an impact sensor may be desirably set based on environmental conditions, such as humidity, the time of day, and/or based on a wide variety of other criteria.

The present description thus proceeds with respect to a system that aggregates sensor signal values over a sample time period. The absolute difference between peaks in the aggregated sensor signal values and a signal trend are identified to obtain a set of absolute difference values corresponding to the sensor. The absolute difference values are sorted based on magnitude and an inflection point corresponding to the sorted absolute difference values is identified. A threshold value corresponding to the sensor is identified based upon the inflection point.

Each impact sensor may have a plurality of different corresponding threshold values where each threshold value is correlated to a set of threshold selection criteria. An impact sensor can then be configured to use one of the corresponding threshold values based on the threshold selection criteria. The threshold selection criteria may be indicative of different contexts, such as machine orientation, environmental parameters, crop characteristics, machine settings, location, time of day, terrain, crop type, crop characteristics, or other threshold selection criteria. During a harvesting operation, the threshold selection criteria can be sensed, and the desired threshold value can be accessed based upon the threshold selection criteria. The impact sensor is configured to detect grain strikes using the accessed threshold value.

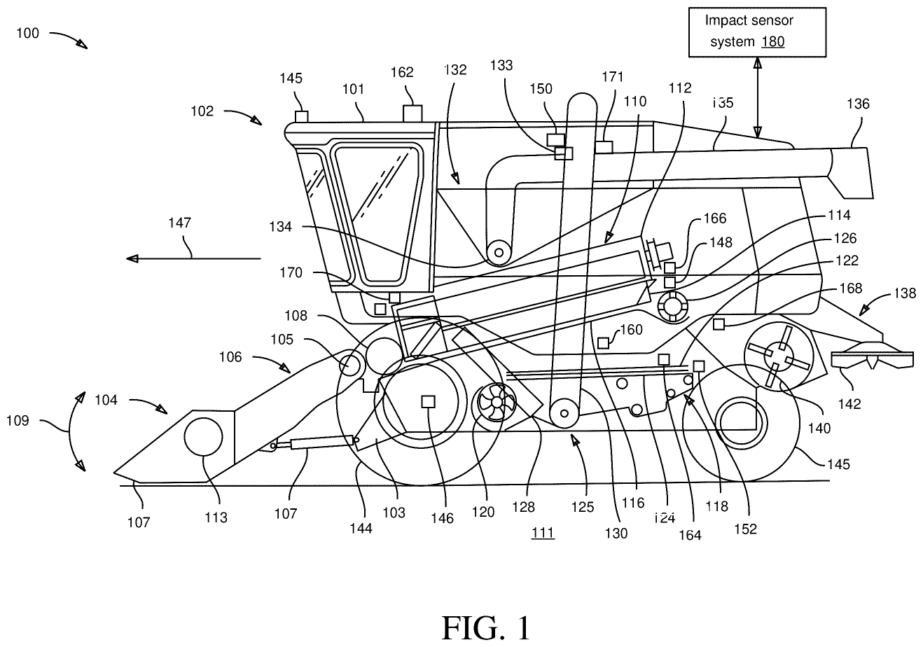

FIG. 1 is a partial pictorial, partial schematic illustration of agricultural harvester 100. Harvester 100 includes a body portion 102 and a header portion (or header) 104, coupled to the body portion 102. Harvester 100 includes an operator compartment 101, a feeder house 106, a feed accelerator 108, and a thresher generally indicated at 110. The feeder house 106 and the feed accelerator 108 form part of a material handling subsystem 125. Header 104 is pivotally coupled to frame 103 of body portion 102 along pivot axis 105. One or more actuators 107 drive movement of header 104 about axis 105 in the direction generally indicated by arrow 109. Thus, a vertical position of header 104 (the header height) above ground 111 over which the header 104 travels is controllable by actuating actuator 107. While not shown in FIG. 1, agricultural harvester 100 may also include one or more actuators that operate to apply a tilt angle, a roll angle, or both to the header 104 or portions of header 104.

Thresher 110 illustratively includes a threshing rotor 112 and a set of concaves 114. Further, agricultural harvester 100 also includes a separator 116. Agricultural harvester 100 also includes a cleaning subsystem or cleaning shoe (collectively referred to as cleaning subsystem 118) that includes a cleaning fan 120, chaffer 122, and sieve 124. The material handling subsystem 125 also includes discharge beater 126, tailings elevator 128, and clean grain elevator 130. The clean grain elevator 130 moves clean grain into clean grain tank 132.

Harvester 100 also includes a material transfer subsystem that includes a conveying mechanism 134, a chute 135, and a spout 136. Conveying mechanism 134 can be a variety of different types of conveying mechanisms, such as an auger or blower. Conveying mechanism 134 is in communication with clean grain tank 132 and is driven (e.g., hydraulicly, mechanically, electrically, etc.) to convey material from clean grain tank 132 through chute 135 and spout 136. Chute 135 is rotatable through a range of positions (shown in the storage position in FIG. 1) away from agricultural harvester 100 to align spout 136 relative to a material receptacle (e.g., grain cart, towed trailer, etc.) that is configured to receive the material. Spout 136, in some examples, is also rotatable to adjust the direction or trajectory of the crop stream exiting spout 136.

Harvester 100 also includes a residue subsystem 138 that can include chopper 140 and spreader 142. Harvester 100 also includes a propulsion subsystem that includes an engine that drives ground engaging traction components, such as wheels 144 or 144 and 145, to propel the harvester 100 across a worksite such as a field (e.g., ground 111). In some examples, a harvester within the scope of the present disclosure may have more than one of any of the subsystems mentioned above. In some examples, harvester 100 may have left and right cleaning subsystems, separators, etc., which are not shown in FIG. 1.

In operation, and by way of overview, harvester 100 illustratively moves through a field in the direction indicated by arrow 147. As harvester 100 moves, header 104 engages crop plants to be harvested and separates the crop material (e.g., the ear or the head) from the plants.

The separated crop material is engaged by a cross auger 113 which conveys the separated crop material to a center of the header 104 where the severed crop material is then moved through a conveyor in feeder house 106 toward feed accelerator 108, which accelerates the separated crop material into thresher 110. The separated crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow.

Grain falls to cleaning subsystem 118. Chaffer 122 separates some larger pieces of material from the grain, and sieve 124 separates some of finer pieces of material from the clean grain. Clean grain falls to an auger that moves the grain to an inlet end of clean grain elevator 130, and the clean grain elevator 130 moves the clean grain upwards, depositing the clean grain in clean grain tank 132. Residue is removed from the cleaning subsystem 118 by airflow generated by cleaning fan 120. Cleaning fan 120 directs air along an airflow path upwardly through the sieves and chaffers. The airflow carries residue rearwardly in harvester 100 toward the residue handling subsystem 138.

Tailings elevator 128 returns tailings to thresher 110 where the tailings are re-threshed. Alternatively, the tailings also may be passed to a separate re-threshing mechanism by a tailings elevator or another transport device where the tailings are re-threshed.

Harvester 100 can include a variety of sensors, some of which are illustrated in FIG. 1, such as location sensor 145, ground speed sensor 146, one or more separator loss sensors 148, a clean grain camera 150, and one or more loss sensors 152 provided in the cleaning subsystem 118. Harvester 100 may also include a variety of different detection criteria sensors, which may sense criteria used to determine when a threshold value for one or more of the impact sensors should be detected, and threshold selection criteria sensors which sense criteria used to select a threshold value to be used by one or more impact sensors. Some examples of the detection criteria and threshold selection criteria are described elsewhere herein. In one example, such sensors can include such things as body pressure sensor 160, barometric pressure sensor 162, chaff volume sensor 164, material other than grain (MOG) volume sensor 166, a crop property sensor, such as MOG moisture sensor 168, crop moisture sensor 170, etc.

Location sensor 145 can be a global navigation satellite system (GNSS) receiver, a cellular triangulation system, a dead reckoning system, or another type of sensor that provides the location of harvester 100 in a global or local coordinate system.

Ground speed sensor 146 senses the travel speed of harvester 100 over the ground 111. Ground speed sensor 146 may sense the travel speed of the harvester 100 by sensing the speed of rotation of the ground engaging traction components (such as wheels or tracks), a drive shaft, an axle, or other components. In some instances, the travel speed may be sensed using the input from other sensors such as position sensor 145. In other examples, the ground speed may be sensed using a Doppler speed sensor, or a wide variety of other systems or sensors that provide an indication of travel speed. Ground speed sensors 146 can also include an orientation sensor or a direction sensor such as a compass, a magnetometer, a gravimetric sensor, a gyroscope, GPS derivation, an inertial measurement unit or other functionality to determine the orientation and/or direction of travel in two or three dimensions in combination with the speed. Thus, when harvester 100 is on a slope, the orientation of harvester 100 relative to the slope may be known. For example, an orientation of harvester 100 could include ascending, descending, or transversely travelling on a sidehill (e.g., tilted to one side or another).

Separator loss sensor 148 provides a signal indicative of grain loss in the left and right separators (not separately shown in FIG. 1). The separator loss sensors 148 may be associated with the left and right separators and may be impact sensors (also referred to herein as strike sensors) which count grain strikes per unit of time or per unit of distance traveled to provide an indication of the grain loss occurring at the separator 110. Sensors 148 may provide separate grain loss signals or a combined or aggregated signal. Sensors 148 may detect a grain strike and generate a voltage signal indicative of the grain strike. For instance, sensors 148 may generate an output signal that shows a voltage spike in response to a grain strike.

Loss sensors 152 illustratively provide an output signal indicative of the quantity of grain loss occurring in both the right and left sides of the cleaning subsystem 118. In some examples, sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal (e.g., a voltage spike responsive to a grain strike), like sensors 148. In some examples, sensors 152 may include a single sensor as opposed to separate sensors provided for each cleaning subsystem 118.

Clean grain camera 150 illustratively observes the grain that is being conveyed into or has been conveyed into clean grain tank 132. Clean grain camera 150 may detect various characteristics, such as the cleanliness of the grain within or being conveyed to clean grain tank 132. For example, clean grain camera 150 may detect an amount of MOG comingled with the grain within or being provided to clean grain tank 132.

Body pressure sensor 160 senses the pressure in the body of harvester 100. Cleaning fan 120 may cooperate with a set of vents to increase or decrease the pressure inside the body of harvester 100. As the fan speed increases and/or the vents are closed, the pressure in the body of harvester 100 increases. As the fan speed decreases and/or the vents are opened, the pressure decreases. Sensor 160 may be a diaphragm sensor or another sensor.

Barometric sensor 162 senses the atmospheric pressure in the environment of harvester 100.

Chaff volume sensor 164 senses the volume of chaff being processed by harvester 100 and generates an output signal indicative of the sensed volume. For instance, chaff volume sensor 164 may sense the volume of material on the cleaning shoe 118. That volume is indicative of the amount of chaff in the system. Thus, chaff volume sensor 164 may be an optical sensor that captures an image of the chaff on cleaning shoe 118 and processes that image to generate a volume output indicative of the volume of the chaff. Chaff volume sensor 164 may be another type of contact sensor or noncontact sensor as well.

MOG volume sensor 166 senses the volume of MOG being processed by harvester 100 and generates an output indicative of that volume. Thus, MOG volume sensor 166 may sense the amount of material on separator 110. MOG volume sensor 166 may thus be an optical sensor, or another type of sensor that senses the volume of MOG on separator 110.

Harvester 100 may include other sensors that sense characteristics of the harvested crop. Such characteristics can be moisture or other characteristics. For instance, MOG moisture sensor 168 may be a capacitive sensor or another sensor that senses the moisture content of the MOG in harvester 100. Harvested material moisture sensor 170 may also be a capacitive sensor or another type of sensor that senses the moisture of the kernels being harvested by harvester 100.

The sensors can include a wide variety of other sensors as well. For instance, a kernel weight sensor 171 can be used to accumulate a number of kernels to obtain a kernel weight metric (such as a thousand kernel weight value) which is indicative of the weight of a given number of kernels (e.g., a thousand kernels). A capture chamber can be used to divert kernels from the clean grain traveling through elevator 130. An optical sensor or other sensor can be used to count the number of kernels captured and a scale or other measurement mechanism can be used to measure the weight of the captured kernels. Other ways of obtaining a kernel weight value are contemplated herein as well. Further, the sensors can include a mass flow rate sensor which may sense the mass flow of material through harvester 100. Such a sensor may sense the rotor pressure of rotor 112, or the mass of material flowing through clean grain elevator 130, or elsewhere. These and other sensors are contemplated herein. Further, a grain flow sensor or yield sensor 133 can be located to sense the amount of grain or yield of grain or other harvested crop. Sensor 133 can sense clean grain flowing through the harvester per unit of time. Sensor 133 can be an impact sensor similar to loss sensors 148 and 152.

It may be that the crop characteristics, environment characteristics, machine settings, or other variables change so with that the threshold values used by the impact sensors (e.g., sensors 133, 148, and/or 152) should be changed to improve the accuracy of those sensors. For example, as sensors age, they may become less sensitive. Therefore, after a certain time has elapsed, the threshold values corresponding to the different impact sensors may desirably be recalibrated or recalculated. Similarly, if the harvested crop changes (e.g., the crop changes from corn to wheat), then the threshold values used by the impact sensors 133, 148, and/or 152 may desirably be changed as well, to increase the accuracy of those sensors. There may be a wide variety of other variables that change, for which a corresponding change in the threshold values used by the impact sensors should also be changed. For instance, if the crop moisture changes, if the orientation of harvester 100 changes, if the environmental or other crop characteristics change, if machine settings change, or for any of wide variety of other changes, it may be desirable to change the threshold values used by the impact sensors 133, 148, and/or 152.

Therefore, in one example, impact sensor system 180 is provided to detect when the threshold values for the impact sensors should be updated, and to generate new or updated threshold values, when desirable. Thus, impact sensor system 180 may receive sensor signals from various sensors and may process those sensor signals to determine whether the threshold values for one or more of the different impact sensors 133, 148, and/or 152 should be updated or changed. If so, then impact sensor system 180 can compute a new threshold value for each impact sensor or retrieve a pre-computed threshold value based upon the detected criteria

The impact sensors 133, 148, and/or 152 can then be dynamically updated (e.g., updated during machine operation) to detect grain strikes using the new threshold values. It will be noted that, in one example, the threshold values used by the impact sensors correspond to voltage thresholds so that, when the impact sensor produces a voltage that exceeds the threshold value, this is interpreted as a grain strike. In another example, the threshold values may also include a minimum time threshold so that, where grain strikes the impact sensor, and the grain strike produces multiple peaks or bounces in the sensor signal those peaks will not be double counted as grain strikes. Instead, for a voltage spike to be counted as a grain strike, the voltage spike is separated from other voltage spikes by a minimum time threshold. Either or both the voltage threshold values (e.g., peak threshold value and/or the time threshold value) can be updated by impact sensor system 180, dynamically, during the harvesting operation, based upon detected criteria.

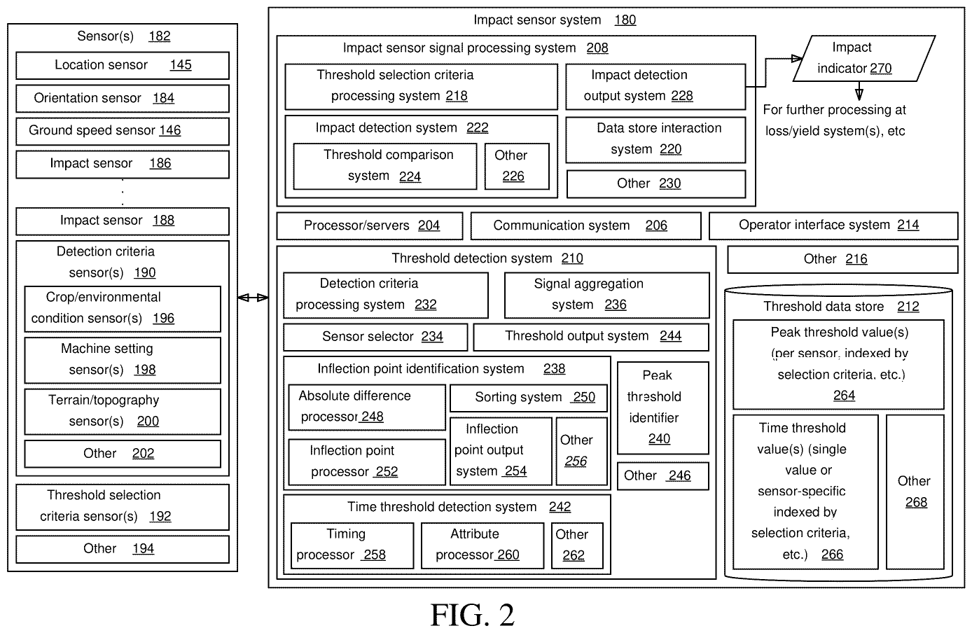

FIG. 2 is a block diagram of one example of an impact sensor system 180 in more detail. In the example described herein, some or all the components of impact sensor system 180 can be disposed on agricultural harvester 100, on a remote system (e.g., in the cloud), or distributed among different systems at different locations. The items in impact sensor system 180 are shown in a single location in FIG. 2 for the sake of example only.

In the example shown in FIG. 2, impact sensor system 180 receives sensor signals from a set of sensors 182. Sensors 182 can include location sensor 145, orientation sensor 184, ground speed sensor 146, impact sensors 186-188 (which may be configured as impact sensors 133, 148, and/or 152 shown in FIG. 1, or other impact sensors). Sensors 182 can also include detection criteria sensors 190, threshold selection criteria sensors 192, and other sensors 194.

Detection criteria sensors 190 can be used to detect variables that are used as criteria to determine when new threshold values should be generated for impact sensors 186-188. Therefore, detection criteria sensors 190 can include such things as crop/environmental condition sensors 196, machine settings sensors 198, terrain/topography sensors 200, or and/or other detection criteria sensors 202. The crop/environmental conditions sensors 196 can include such things as MOG moisture sensor 168, crop moisture sensor 170, kernel weight sensor 171, humidity sensors, and/or any of wide variety of other sensors that since crop conditions or environmental conditions. Machine settings sensors 198 can be used to sense machine settings, such as the fan speed for cleaning fan 120, chaffer and sieve clearance, machine configuration, and/or other machine settings. Terrain/topography sensor 200 can sense the terrain and/or topography of the ground 111 over which agricultural harvester 100 is traveling. Terrain/topography sensor 200 can thus be used to read a terrain or topography map and correlate the map values to a current location of harvester 100, sense machine orientation using orientation sensors (such as an inertial measurement unit, a gyroscopic sensor, or other sensors), etc.

Threshold selection criteria sensors 192 detect variables indicative of criteria that may be used to select a threshold value (from among a plurality of different threshold values) for a particular impact sensor 186-188. For instance, there may be different threshold values that are desirably used by an impact sensor 186-188 under different crop moisture conditions. Thus, threshold selection criteria sensors 192 may include a crop moisture sensor and the sensor value is used to determine which detection threshold value should be used for one or more of the different impact sensors 186-188. Threshold selection criteria sensors 192 can be used to sense any of a wide variety of other threshold selection criteria which are not sensed by other sensors. The threshold selection criteria sensors may sense or otherwise determine the type of crop being harvested by agricultural harvester 100, the time of day, and/or any of wide variety of other criteria that can be used to select a threshold for an impact sensor.

In the example shown in FIG. 2, impact sensor system 180 includes one or more processors or servers 204, communication system 206, impact sensor signal processing system 208, threshold detection system 210, threshold data store 212, operator interface system 214, and other items 216. Impact sensor signal processing system 208 includes threshold selection criteria processing system 218, data store interaction system 220, impact detection system 222 (which, itself, includes threshold comparison system 224 and other functionality 226), impact detection output system 228, and other items 230. Threshold detection system 210 can include detection criteria processing system 232, sensors selector 234, signal aggregation system 236, inflection point identification system 238, peak threshold identifier 240, time threshold detection system 242, threshold output system 244, and other items 246. Inflection point identification system 238 can include absolute difference processor 248, sorting system 250, inflection point processor 252, inflection point output system 254, and other items 256. Time threshold detection system 242 can include timing processor 258, attribute processor 260, and other items 262.

Threshold data store 212 can include one or more peak threshold values 264 which may be values generated for each sensor, values indexed by threshold selection criteria, etc. Threshold data store 212 can also include one or more time threshold values 266. Time threshold values 266 may include a single value that is used for all impact sensors 186-188, sensor-specific values, values that are indexed by time threshold selection criteria, and/or other values configured in other ways. Threshold data store 212 can include other items 268 as well. Before describing the overall operation of impact sensor system 180 in more detail, a description of some of the items in impact sensor system 180, and their operation, will first be provided.

Communication system 206 facilitates communication among the items and/or components of impact sensor system 180 and can also facilitate communication with other systems, remote from impact sensor system 180, and systems remote from agricultural harvester 100. Therefore, communication system 206 can include a controller area network-CAN-bus and bus controller, a wide area communication system, a local area communication system, a near field communication system, a Wi-Fi or Bluetooth communication system, a cellular communication system, and/or any of wide variety of other communication systems or combinations of systems. Impact sensor signal processing system 208 receives sensor signals from impact sensors 186-188 and processes those signals to generate an impact indicator 270 indicative of the number of impacts per unit time (e.g., grain strikes per second, etc.) or the number of impacts per distance traveled (e.g., grain strikes per meter, etc.), an aggregate number of grain strikes, or another indicator indicating grain strikes in other ways.

Threshold selection criteria processing system 218 receives inputs from the threshold selection criteria sensors 192 and processes those inputs. Data store interaction system 220 accesses threshold data store 212 based upon the threshold selection criteria to identify a peak threshold value 264 and/or a time threshold value 266 for use by one or more of the impact sensors 186-188, based upon the detected threshold selection criteria. For instance, where different peak thresholds 264 are selected for an impact sensor 186 based upon the type of crop being harvested, then threshold selection criteria processing system 218 detects when the crop type being harvested has changed so that a new peak threshold value 264 can be retrieved for the impact sensor 186. Further, where different peak threshold values 264 are to be used by an impact sensor 186 when the agricultural harvester is oriented in different orientations, then threshold selection criteria processing system 218 processes the input from orientation sensor 184 to determine when the orientation (e.g. pitch and/or roll) of agricultural harvester 100 has shifted sufficiently that a new peak threshold value 264 should be used. These are just some examples of the different threshold selection criteria that can be used to identify the peak threshold value 264 that should be used for an impact sensor 186-188, and other threshold selection criteria can be used as well, some of which are discussed elsewhere herein.

Impact detection system 222 then uses that peak threshold value 264 and time threshold value 266 to process the impact sensor signals to identify grain strikes. Threshold comparison system 224 compares peaks in the impact sensor signal being processed to the peak threshold value 264 to identify grain strikes. Threshold comparison system 224 also uses the time threshold value 266 to reduce the likelihood of double counting a grain strike (e.g., where a single kernel bounces on the impact sensor or otherwise causes multiple peaks in the impact sensor signal). Impact detection system 222 generates an output indicative of grain strikes and impact detection output system 228 receives the output from impact detection system 222 and generates the impact indicator 270. Impact indicator 270 can be output to other systems for further processing, such as to generate a grain loss signal, a yield signal, or other signals. Impact detection output system 228 can thus aggregate the number of grain strikes over time, over distance traveled, or in other ways to generate impact indicator 270.

Threshold detection system 210 determines whether an impact sensor 186-188 should have its peak threshold value re-calculated or updated. For instance, as impact sensors 186-188 age, they may become less sensitive, or their sensitivity may change in other ways. Therefore, detection criteria processing system 232 may determine that a sufficient time has elapsed that the peak threshold value for a particular image sensor should be updated. Further, the peak threshold value may need to be recomputed or updated when agricultural harvester 100 changes geographic locations, changes orientations, has machine settings changed, where environmental or crop characteristics change, or for any of wide variety of other reasons. Detection criteria processing system 232 detects those criteria and generates an output indicating whether the peak threshold values for one or more impact sensors 186-188 should be recomputed or updated.

When the threshold values for one or more impact sensors 186-188 are to be updated, then sensor selector 234 selects a sensor 186-188 for which a new threshold value is to be calculated or updated. It will be noted that, in one example, threshold detection system 210 can recompute or update or generate a threshold value for multiple impact sensors 186-188 at the same time. However, for the sake of the present discussion, threshold detection system 210 will be described as generating or calculating a threshold value for a single impact sensor 186-188 at a time. This is for the sake of example only and parallel or other threshold generation can be performed as well.

Signal aggregation system 236 aggregates signal values in the sensor signal generated by the selected sensor for a sample time period. For instance, the sensor signal values can be stored for a sample time period so that threshold processing can be performed.

Inflection point identification system 238 identifies an inflection point corresponding to the aggregated sensor signal. For instance, absolute difference processor 248 identifies the absolute differences between peaks in the sensor signal and a trend corresponding to the sensor signal. Sorting system 250 sorts the absolute different values according to magnitude (e.g., in increasing order or in decreasing order) and inflection point processor 252 identifies an inflection point corresponding to the sorted absolute difference values. Inflection point output system 254 generates an output indicative of the inflection point. Peak threshold identifier 240 generates a peak threshold value 264 corresponding to the selected sensor based upon the inflection point. For instance, peak threshold identifier 240 can identify, as the inflection point, the voltage generated by the selected impact sensor at the inflection point. Peak threshold identifier 240 can identify the peak threshold value 264 for the selected sensor, based upon the inflection point, in other ways as well.

Time threshold detection system 242 computes or modifies the time threshold value 266 for the selected sensor. Timing processor 258 can identify peaks in the sensor signal value that are located so close to one another that they likely correspond to a single grain strike. Attribute processor 260 can generate a time threshold value based upon different attributes corresponding to the harvesting operation. For instance, the time threshold value 266 may vary based upon the crop type, based upon the expected seed or grain size, or based upon other attributes or characteristics of the crop, of the environment, of the harvesting operation, of the agricultural harvester, etc.

Threshold output system 244 generates an output indicative of the peak threshold value 264 generated by peak threshold identifier 240 and/or of the time threshold value 266 generated by time threshold detection system 242. Those values can be provided to impact sensor signal processing system 208 for incorporation into impact detection system 222, as well as output to threshold data store 212 for storage. The peak threshold value 264 and time threshold value 266 can be stored on a per-sensor basis, for a group of impact sensors, etc. In addition, the peak threshold values 264 and time threshold value 266 can be stored along with, or indexed by, the threshold selection criteria that are used to select the peak threshold value 264 and time threshold value 266 for an impact sensor 186-188. The peak threshold value 264 and time threshold value 266 can be stored in other ways as well.

Operator interface system 214 can be used to output information to an operator and to receive inputs from an operator. Therefore, user interface displays can be generated and displayed using touch sensitive display elements, icons, links, etc. Other operator input mechanisms can include a variety of user input mechanisms that can be used to generate outputs for an operator and receive inputs from an operator. These can include such things as switches, levers, push buttons, keypads, pedals, steering wheels, joysticks, etc.

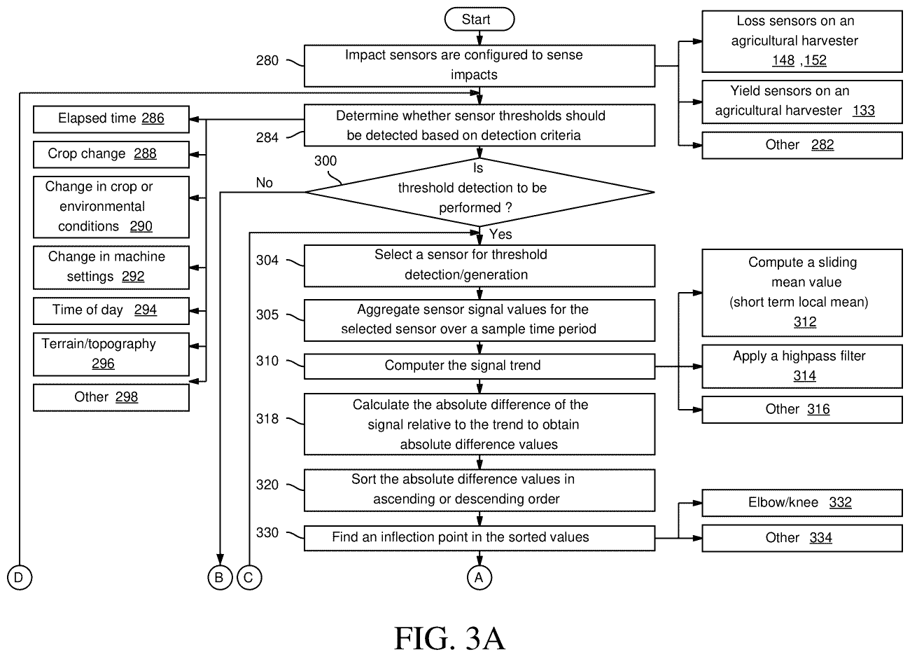

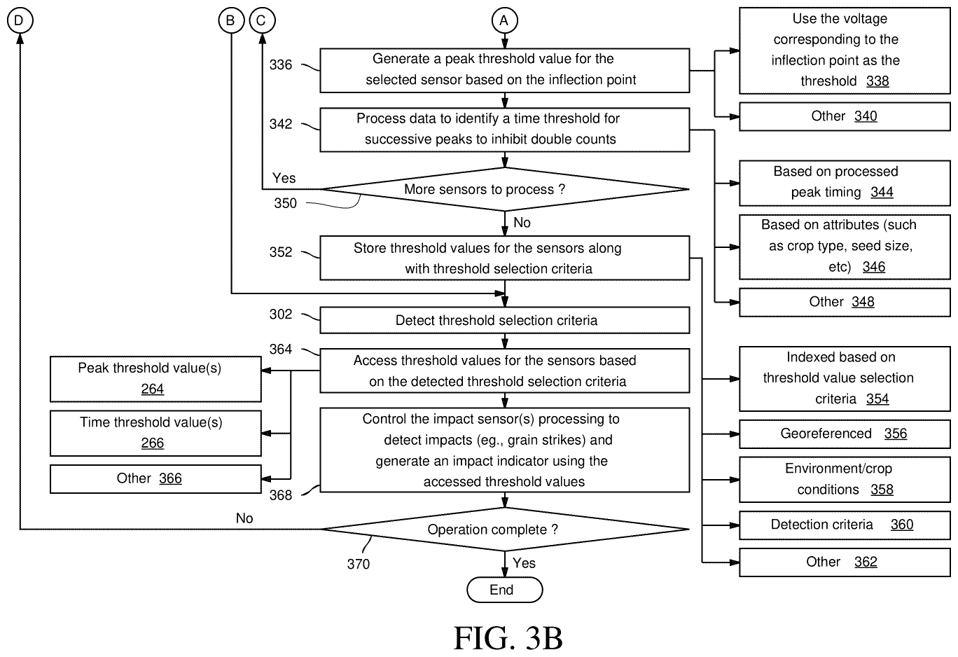

FIGS. 3A and 3B (collectively referred to herein as FIG. 3) show a flow diagram illustrating one example of the operation of impact sensor system 180 in generating threshold values for impact sensors 186-188, updating those values, and selecting different values based upon different selection criteria. It is first assumed that impact sensors 186-188 are configured to sense impacts, as indicated by block 280 in the flow diagram of FIG. 3. Again, the impact sensors 186-188 can be loss sensors 148, 152 on agricultural harvester 100. The impact sensors 186-188 can be yield sensors 133 on agricultural harvester 100, or other impact sensors 282.

Detection criteria processing system 232 receives signals from detection criteria sensors 190 and determines whether threshold values 264 and/or 266 should be detected based upon the detection criteria. Processing the detection criteria to determine whether sensor signal threshold value should be generated as indicated by block 284 in the flow diagram of FIG. 3. In one example, new threshold values 264 and/or 266 are generated intermittently based upon a predetermined or dynamic time interval. Thus, the detection criteria include elapsed time 286.

In another example, the threshold values 264 and/or 266 are determined based upon the crop type. Therefore, the detection criteria include crop change criteria 288 indicating that the crop type being harvested by agricultural harvester 100 has changed since the last time the threshold values 264 and/or 266 were computed. In another example, the detection criteria include environmental conditions and/or crop conditions 290. Therefore, when the environmental or crop conditions have changed since the last time the threshold values 264 and/or 266 were generated, then detection criteria processing system 232 generates an output indicating that new sensor threshold values 264 and/or 266 are to be generated. In another example, the detection criteria can include machine settings. Therefore, if the machine settings 292 have changed since the last time the threshold values 264 and/or 266 were generated, then the detection criteria processing system 232 can determine that the threshold values 264 and/or 266 should be generated or updated. In another example, different threshold values 264 and/or 266 are desirably used at different times of day 294. Therefore, detection criteria processing system 232 can generate an output indicating that new threshold values 264 and/or 266 should be generated based upon the time of day 294. In yet another example, it may be that new threshold values 264 and/or 266 should be generated based upon the terrain or topography 296 of the ground or field 111 over which agricultural harvester 100 is traveling. Therefore, detection criteria processing system 232 can generate an output indicating that new threshold values 264 and/or 266 should be generated based upon the terrain or topography 296. Of course, a wide variety of other detection criteria 298 can be used to determine whether the threshold values 264 and/or 266 should be updated.

If, at block 300, it is determined that the threshold values 264 and/or 266 need not be updated or generated, then processing continues at block 302 where threshold selection criteria processing system 218 determines whether the threshold values 264 and/or 266, that are currently being used by impact sensors 186-188, can continue to be used, as is described in greater detail below. However, if, at block 300, detection criteria processing system 232 determines that the threshold values 264 and/or 266 should be generated or updated, then sensor selector 234 selects an impact sensor 186-188 for which new threshold values 264 and/or 266 are to be generated. Selecting a sensor for threshold detection/generation is indicated by block 304 in the flow diagram of FIG. 3. Again, it will be noted that threshold detection system 210 can generate thresholds for multiple impact sensors at the same time, or sequentially. The present discussion proceeds with respect to detecting and/or generating threshold values for a single, selected impact sensor at a time, but this is described for the sake of example only.

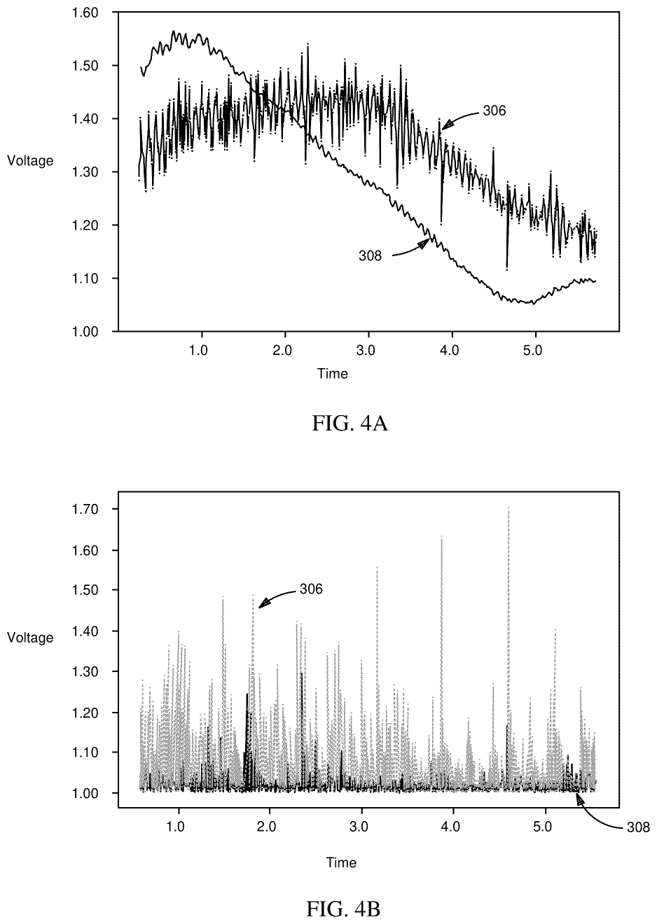

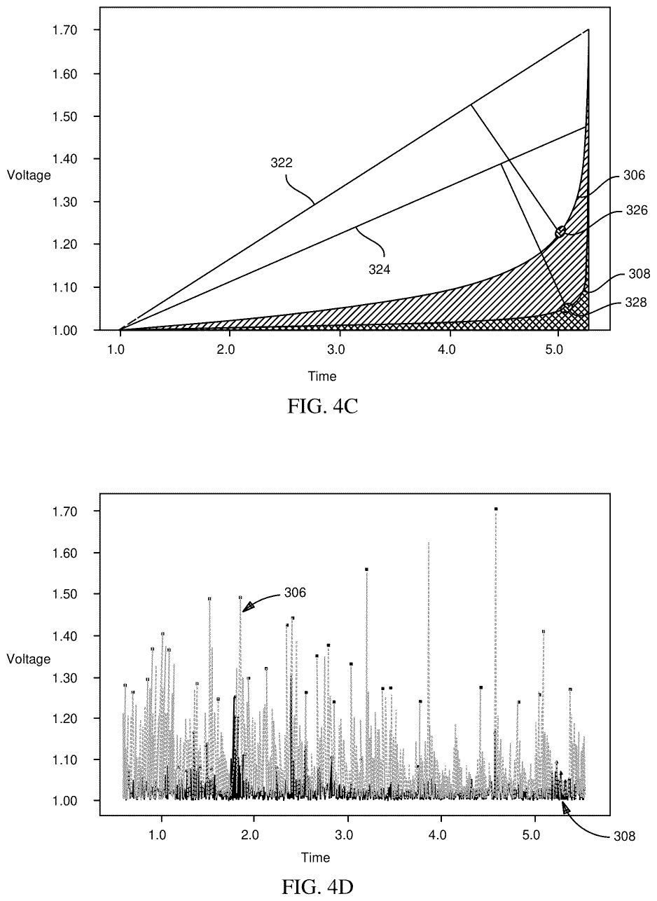

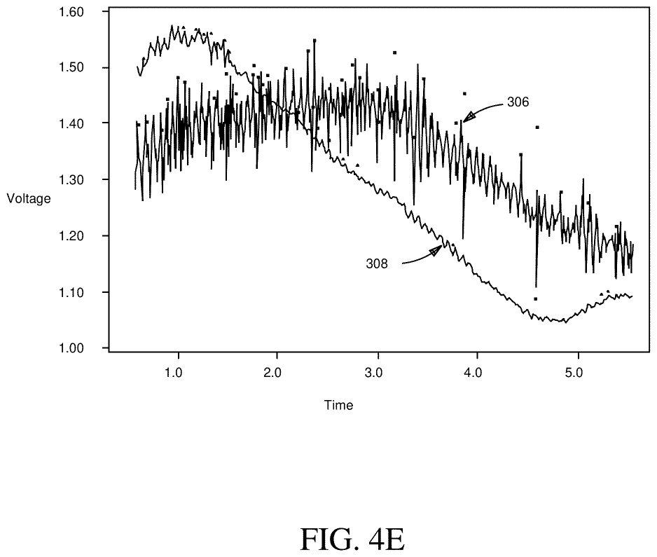

Signal aggregation system 236 then aggregates an impact sensor signal for the selected impact sensor (it is assumed for the sake of discussion that impact sensor 186 is the selected impact sensor) for a sample time period. Aggregating sensor signal values for the selected sensor over a sample time period is indicated by block 305 in the flow diagram of FIG. 3. FIG. 4A, for instance, shows aggregated sensor signals from two different sensors. FIG. 4A shows two different plots 306 and 308 on a graph, where time is represented along the x-axis and voltage is represented along the y-axis. The first plot shown generally at 306 represents a first sensor signal from a first impact sensor. The second plot 308 represents a second sensor signal from a second impact sensor. The sensor signal 306 from the first impact sensor varies more widely, in response to grain strikes, than the sensor signal 308 from the second impact sensor.

Inflection point identification system 238 then processes the aggregated sensor signal values to identify an inflection point. To obtain the inflection point, absolute difference processor 248 computes the signal trend corresponding to the aggregated sensor signal. Computing the signal trend is indicated by block 310 in the flow diagram of FIG. 3. In one example, the trend is computed as a sliding mean value corresponding to the aggregated signal values, which may be a short-term, local mean corresponding to the aggregated signal. Computing a sliding mean value to represent the signal trend is indicated by block 312. In another example, a high pass filter is applied to the aggregated signal to remove low-frequency components representing the signal trend. Applying a high pass filter is indicated by block 314 in the flow diagram of FIG. 3. The signal trend can be computed in other ways as well, as indicated by block 316. Absolute difference processor 248 then calculates the absolute difference of the aggregated signal relative to the trend to obtain a set of absolute difference values, as indicated by block 318 in the flow diagram of FIG. 3.

FIG. 4B shows a graph that is similar to that shown in FIG. 4A, except that in FIG. 4B, the trend for the two aggregated sensor signals 306 and 308 has been removed. Thus, FIG. 4B shows the absolute difference in the aggregated signal values (which are illustrated in FIG. 4A) from the trend. FIG. 4B shows that the absolute difference values for signal 306 are much larger than the absolute difference values for signal 308 due to the difference in sensitivity of the two impact sensors to grain strikes. Because the absolute difference values for the two impact sensors are so different, the peak threshold values should be different for the two sensors as well.

Sorting system 250 then sorts the absolute difference values based on magnitude. Sorting system 250 can sort the absolute difference values based on magnitude in ascending order, or descending order, for example. Sorting the absolute difference values based on magnitude is indicated by block 320 in the flow diagram of FIG. 3. FIG. 4C shows one example in which the absolute difference values for signal 306 and for signal 308 are sorted in ascending order.

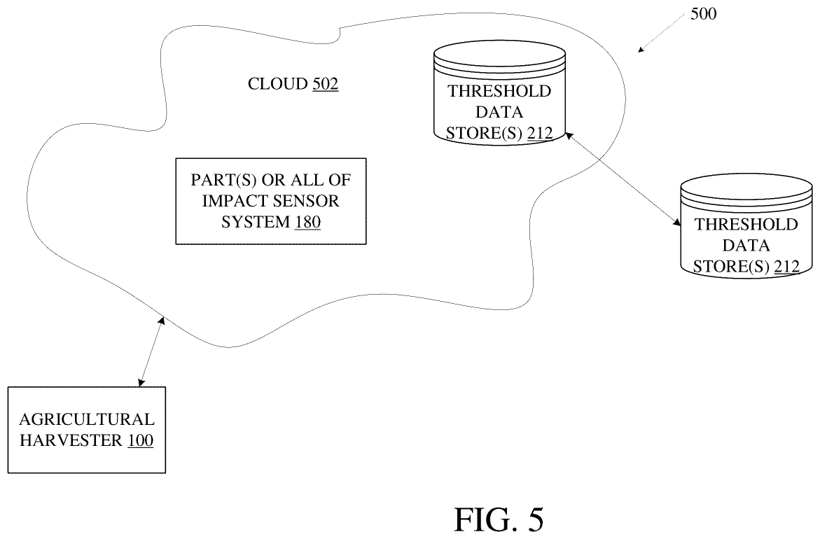

Inflection point processor 252 then finds an inflection point in the sorted absolute difference values. The inflection point can be detected in a number of ways, such as by detecting a knee or elbow in the curve representing the sorted absolute difference values. The knee or elbow can be detected, for instance, using the Kneedle algorithm or in a wide variety of other ways. FIG. 4C shows that, in one example, inflection point processor 252 identifies the inflection point corresponding to signal 306 as the point along the curve defined by the aggregated signal values for signal 306 that is furthest from a line 322 that connects the first and last points in the sorted absolute difference values. Similarly, inflection point processor 252 identifies the inflection point corresponding to signal 308 as the point along the sorted values that is furthest from the line 324 between the first and last sorted absolute difference values. The inflection point for sensor signal 306 will thus be the voltage that corresponds to point 326, and the inflection point for signal 308 will thus be the voltage that corresponds to point 328. Finding the inflection point in the sorted absolute difference values is indicated by block 330 in the flow diagram of FIG. 5. Finding the inflection point by identifying an elbow or knee in the curve defined by the sorted values is indicated by block 332, and finding the inflection point in other ways is indicated by block 334.

Inflection point output system 254 then generates an output indicative of the identified inflection point. Peak threshold identifier 240 identifies a peak threshold value corresponding to the selected sensor based upon the inflection point. Generating a peak threshold value for the selected sensor based on the inflection point is indicated by block 336 in the flow diagram of FIG. 3. In one example, the peak threshold value is the voltage corresponding to the inflection point for the selected sensor, as indicated by block 338. The peak threshold value can be identified based upon the inflection point in other ways as well, as indicated by block 340.

Time threshold detection system 242 then processes data to identify a time threshold for successive peaks that can be used to inhibit double counts of a single piece of grain. Identifying a time threshold is indicated by block 342 in the flow diagram of FIG. 3. In one example, time processor 258 identifies the timing between successive peaks and calculates a value that can be used as the time threshold so that if two peaks are identified within the time threshold, they are counted only as a single peak. Identifying the time threshold based upon processed peak timing data is indicated by block 344. Attribute processor 260 can identify a time threshold value based upon other attributes of the harvesting operation, such as crop type, expected or measured grain size, or other environmental conditions, crop conditions, machine settings, or machine conditions, etc. For instance, given a crop type, a time threshold value can be looked up in a table of pre-computed time threshold values or obtained ion another way. Identifying the time threshold based upon such attributes as indicated by block 346 in the flow diagram of FIG. 3. Time threshold detection system 242 can use other items 262 to calculate the time threshold in other ways as well, as indicated by block 348.

If there are more sensors for which threshold values are to be generated, as determined at block 350, then processing reverts to block 304 where sensor selector 234 selects another sensor so that a signal can be aggregated, and the threshold value can be generated. When threshold values have been generated for all desired sensors, or at some other point in the processing, the threshold values for the sensors, along with threshold selection criteria, are stored in threshold data store 212. Storing the threshold values as indicated by block 352 in the flow diagram of FIG. 3. In one example, the threshold values can be indexed based upon the threshold value selection criteria, as indicated by block 354. In another example, the threshold values can be geo-referenced threshold values so that, as the location of agricultural harvester 100 changes (as determined by the output of location sensor 145, for instance), then new threshold values can be accessed for the impact sensors. Storing the threshold values as geo-referenced values is indicated by block 356 and the flow diagram of FIG. 5. The threshold values can be stored along with, or indexed based on, environment and/or crop conditions, as indicated by block 358, based upon any of the detection criteria discussed above with respect to blocks 286-298 or other detection criteria, as indicated by block 360, or the threshold values can be stored and/or indexed in a wide variety of other ways, as indicated by block 362.

When a threshold value has been generated for an impact sensor, then impact sensor signal processing system 208 evaluates threshold selection criteria and accesses the stored threshold values 264, 266 based upon the threshold selection criteria and uses the accessed threshold values for identifying grain strikes with impact sensors 186-188. Detecting threshold selection criteria which can be used to select one of a plurality of different peak threshold values 264 and/or time threshold values 266 for a given sensor can be performed by threshold selection criteria processing system 218 and is indicated by block 302 in the flow diagram of FIG. 3. Threshold selection criteria processing system 218 can receive inputs from a wide variety of different types of threshold selection criteria sensors 192 in addition, or instead of, the signals generated by detection criteria sensors 190, location sensor 145, orientation sensor 184, ground speed sensor 146, and any of the other sensors 194. The particular threshold selection criteria that are used by threshold selection criteria processing system 218 can be identified empirically, using various machine learning algorithms, or in other ways.

The values of the threshold selection criteria can be provided to data store interaction system 220 which accesses threshold data store 212 using the threshold selection criteria. For instance, where the peak threshold values 264 and/or the time threshold values 266 are indexed based upon the threshold selection criteria, then data store interaction system 220 can identify the specific threshold values 264, 266 that should be accessed using the threshold selection criteria. Accessing the threshold values 264, 266 based on the detected threshold selection criteria is indicated by block 364 in the flow diagram of FIG. 3. Again, a separate peak threshold value 264 can be obtained for each individual sensor or for one or more groups of sensors, and a separate time threshold value 266 can be obtained for each individual sensor, or for one or more groups of sensors. The threshold values can be accessed in other ways as well, as indicated by block 366 in the flow diagram of FIG. 3.

The threshold values 264, 266 are then provided to impact detection system 222 which uses those threshold values to detect impacts (e.g., grain strikes). Impact detection output system 228 then generates impact indicator 270, indicative of the grain strikes, for further processing.

FIG. 4D, shows one example in which the voltages corresponding to inflection points 326 and 328 are used by impact detection system 222 to identify grain strikes. The grain strikes are identified in sensor signal 306 by the dots located on the peaks in signal 306. Similarly, the grain strikes in sensor signal 308 are also indicated by the dots on the peaks in signal 308. When the peak values exceed the peak threshold values for each signal, and when the peaks are separated by the time threshold value, those peaks are interpreted to be grain strikes.

FIG. 4E shows grain strikes detected in sensor signals 306 and 308 without the trend value removed from those sensor signals. Again, the grain strikes are identified by the dots on the peaks of the signals 306 and 308.

Controlling the impact detection system 222 to detect impacts or grain strikes and using impact detection output system 228 to generate impact indicator 270 using the accessed threshold values is indicated by block 368 in the flow diagram of FIG. 3. Until the operation is complete, as determined that block 370, processing reverts to block 284 where detection criteria processing system 232 continues to evaluate whether the threshold values 264, 266 for any of the impact sensors 186-188 need to be reevaluated or modified.

It can thus be seen that the present description describes a system that aggregates impact sensor signal values and identifies an inflection point in those sensor signal values. The inflection point is used to generate a peak threshold value for sensing grain strikes. A peak threshold value can be generated on a per-impact sensor basis, or for one or more groups of impact sensors. Similarly, the present description describes a system that identifies a time threshold value for individual impact sensors or for groups of impact sensors. The threshold values are dynamically updated during operation of the agricultural harvester and individual threshold values can be selected for the different impact sensors based upon dynamically varying conditions encountered during a harvesting operation. This greatly increases the accuracy of the impact sensors in sensing grain strikes

The present discussion has mentioned processors and servers. In one example, the processors and servers include computer processors with associated memory and timing circuitry, not separately shown. The processors or servers are functional parts of the systems or devices to which they belong and are activated by and facilitate the functionality of the other components or items in those systems.

Also, an operator interface system that can be used to generate user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with functionality distributed among more components.

It will be noted that the above discussion has described a variety of different systems, components, generators, models, sensors, selectors, algorithms, identifiers, and/or logic. It will be appreciated that such systems, components, generators, models, sensors, selectors, algorithms, identifiers, and/or logic can be comprised of hardware items (such as processors and associated memory, or other processing components, some of which are described below) that 31 perform the functions associated with those systems, components, generators, models, sensors, selectors, algorithms, identifiers, and/or logic. In addition, the systems, components, generators, models, sensors, selectors, algorithms, identifiers, and/or logic can be comprised of software that is loaded into a memory and is subsequently executed by a processor or server, or another computing component, as described below. The systems, components, generators, models, sensors, selectors, algorithms, identifiers, and/or logic can also be comprised of different combinations of hardware, software, firmware, etc., some examples of which are described below. These are only some examples of different structures that can be used to form the systems, components, generators, models, sensors, selectors, algorithms, identifiers, and/or logic described above. Other structures can be used as well.

FIG. 5 is a block diagram of the architecture shown in FIG. 2, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 5, some items are similar to those shown in previous FIGS. and they are similarly numbered. FIG. 5 specifically shows that portions of impact sensor system 180, and data store 212, and/or other systems 504 can be located at a remote server location 502. Therefore, agricultural harvester 100 accesses those systems through remote server location 502.

FIG. 5 also depicts another example of a remote server architecture. FIG. 5 shows 31 that it is also contemplated that some elements of previous FIGS are disposed at remote server location 502 while others are not. By way of example, threshold data store 212, and/or other items can be disposed at a location separate from location 502 and accessed through the remote server at location 502. Regardless of where the items are located, the items can be accessed directly by agricultural harvester 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

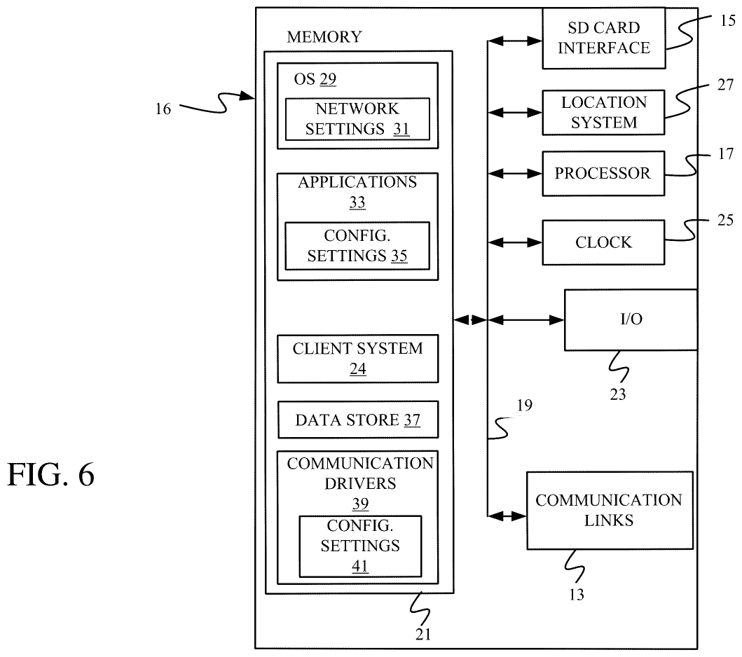

FIG. 6 is a simplified block diagram of one illustrative example of a handheld or mobile computing device that can be used as a user's or client's handheld device 16, in which the present system (or parts of it) can be deployed. For instance, a mobile device can be deployed in the operator compartment of agricultural harvester 100 for use in generating, processing, or displaying the peak threshold data. FIGS. 6-8 are examples of handheld or mobile devices.

FIG. 6 provides a general block diagram of the components of a client device 16 that can run some components shown in previous FIGS., that interact with them, or both. In device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

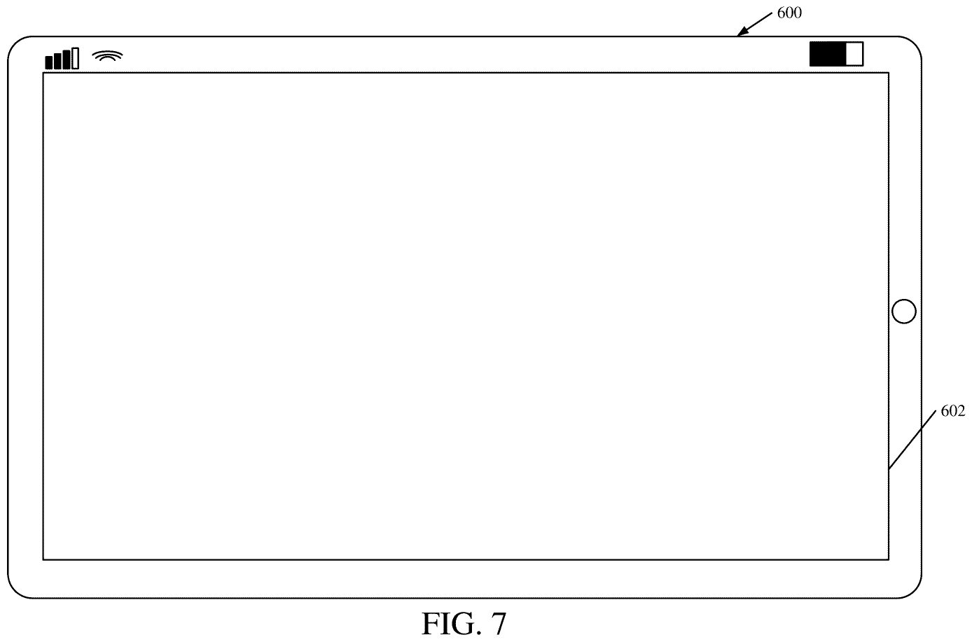

FIG. 7 shows one example in which device 16 is a tablet computer 600. In FIG. 7, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice input as well.

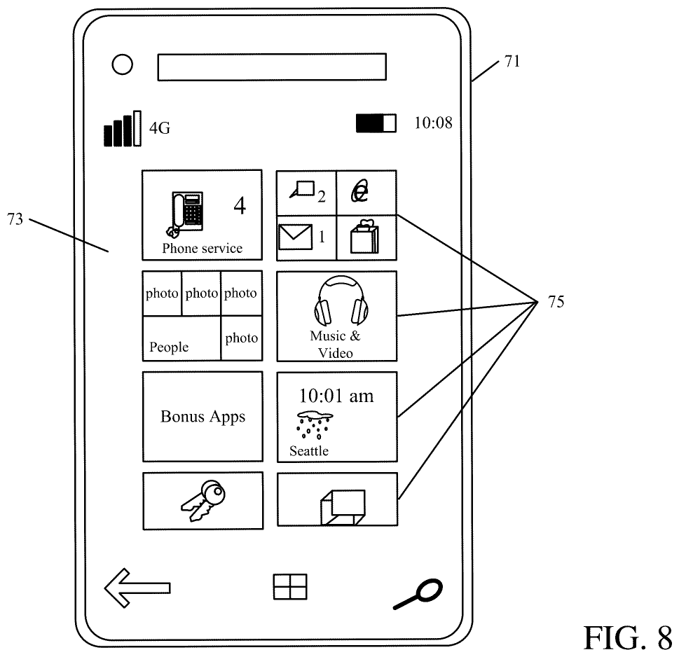

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

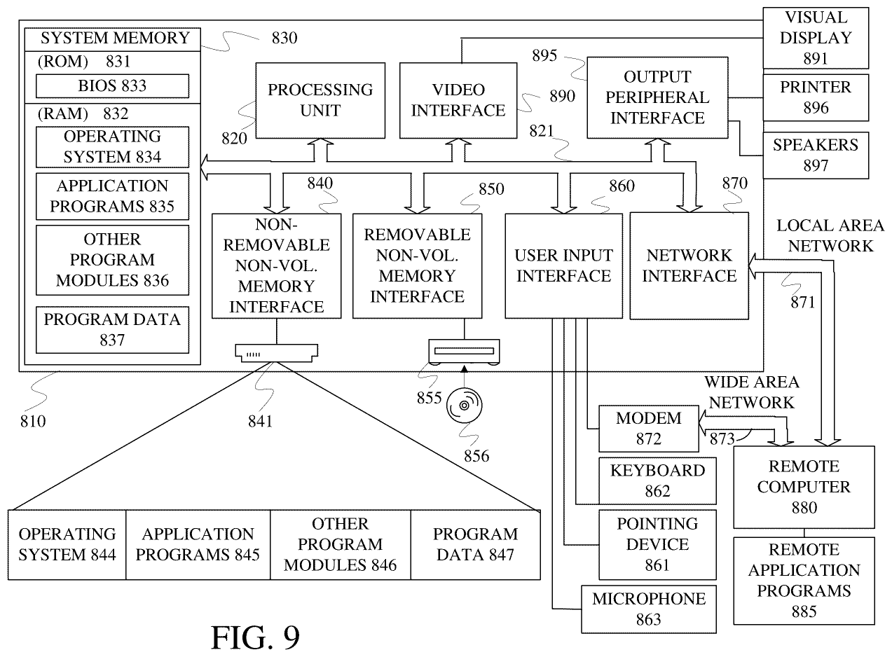

FIG. 9 is one example of a computing environment in which elements of previous FIGS., or parts of it, (for example) can be deployed. With reference to FIG. 9, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

System memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 9 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
obtaining a set of sensor signal values generated by an agricultural impact sensor on an agricultural harvester;
sorting the sensor signal values based on magnitude to obtain sorted sensor signal values;
identifying an inflection point in the sorted sensor signal values;
generating a peak threshold value based on the inflection point; and
generating a control signal to configure the agricultural impact sensor to detect grain strikes based on the peak threshold value.

2. The computer implemented method of claim 1 and further comprising:
detecting a set of threshold detection criteria during operation of the agricultural harvester;
determining whether the peak threshold value is to be updated based on the set of threshold detection criteria; and
if so, repeating the steps of obtaining a set of sensor signal values, sorting the sensor signal values, identifying an inflection point, generating a peak threshold value, and generating a control signal to configure the agricultural impact sensor to detect grain strikes based on the peak threshold value.

3. The computer implemented method of claim 1 and further comprising:
generating a plurality of peak threshold values corresponding to the agricultural impact sensor;
identifying a set of threshold selection criteria values corresponding to each of the plurality of peak threshold values; and
storing the plurality of peak threshold values corresponding to the agricultural impact sensor with the corresponding set of threshold selection criteria values.

4. The computer implemented method of claim 3 and further comprising:
detecting runtime selection criteria values; and
identifying one of the plurality of peak threshold values based on the runtime threshold selection criteria; and
generating a control signal to configure the agricultural impact sensor to detect grain strikes based on the identified peak threshold value.

5. The computer implemented method of claim 4 wherein detecting runtime threshold selection criteria values comprises:
detecting a geographic location of the agricultural harvester, and wherein identifying one of the plurality of peak threshold values comprises identifying the one of the plurality of peak threshold values based on the detected geographic location.

6. The computer implemented method of claim 4 wherein detecting runtime threshold selection criteria values comprises:
detecting an orientation of the agricultural harvester, and wherein identifying one of the plurality of peak threshold values comprises identifying the one of the plurality of peak threshold values based on the detected orientation.

7. The computer implemented method of claim 1 wherein obtaining a set of sensor signal values comprises:
aggregating sensor signal values from the agricultural impact sensor over a sample time period.

8. The computer implemented method of claim 1 and further comprising:
generating a time threshold value based on a set of time threshold criteria; and
generating a control signal to configure the agricultural impact sensor to detect grain strikes based on the time threshold value.

9. The computer implemented method of claim 8 wherein generating a time threshold value comprises:
detecting, as the time threshold criteria, attribute data indicative of attributes of a harvest operation performed by the agricultural harvester; and
generating the time threshold value based on the attribute data.

10. The computer implemented method of claim 1 and further comprising:
generating a grain loss signal with the agricultural impact sensor based on detected grain strikes.

11. The computer implemented method of claim 1 and further comprising:
generating a yield signal with the agricultural impact sensor based on detected grain strikes.

12. The computer implemented method of claim 1 wherein the agricultural impact sensor comprises a plurality of different agricultural impact sensors and further comprising:
obtaining a set of sensor signal values generated by each of the plurality of different agricultural impact sensors on an agricultural harvester;
sorting the sensor signal values, for each of the plurality of different agricultural impact sensors, based on magnitude to obtain a separate set of sorted sensor signal values corresponding to each of the plurality of different agricultural impact sensors;
identifying an inflection point in each set of the sorted sensor signal values;
generating a peak threshold value for each of the plurality of different agricultural impact sensors based on the inflection point in the corresponding set of sorted sensor signal values; and
generating a control signal to configure each of the agricultural impact sensors to detect grain strikes based on the corresponding peak threshold value.

13. An agricultural system, comprising:
a signal aggregation system configured to aggregate a set of sensor signal values generated by an agricultural impact sensor on an agricultural harvester;
an inflection point identification system configured to sort the sensor signal values based on magnitude to obtain sorted sensor signal values and to identify an inflection point in the sorted sensor signal values;
a peak threshold identifier configured to generate a peak threshold value based on the inflection point; and
an impact sensor signal processing system configured to receive a sensor signal from the agricultural impact sensor and detect grain strikes indicated by the sensor signal based on the peak threshold value.

14. The agricultural system of claim 13 and further comprising:
a detection criteria processing system configured to receive a set of threshold detection criteria during operation of the agricultural harvester and determine whether the peak threshold value is to be updated based on the set of threshold detection criteria.

15. The agricultural system of claim 14 wherein, when the detection criteria processing system determines that the peak threshold value is to be updated, the inflection point identification system is configured to sort the sensor signal values and identify an inflection point, and the peak threshold identifier is configured to generate an updated peak threshold value, and the impact sensor signal processing system is configured to generate a control signal to configure the agricultural impact sensor to detect grain strikes based on the updated peak threshold value.

16. The agricultural system of claim 13 wherein the peak threshold identifier is configured to generate a plurality of peak threshold values corresponding to the agricultural impact sensor; and further comprising:
a threshold selection criteria processing system configured to identify a set of threshold selection criteria values corresponding to each of the plurality of peak threshold values; and
a threshold output system configured to store the plurality of peak threshold values corresponding to the agricultural impact sensor with the corresponding set of threshold selection criteria values.

17. The agricultural system of claim 16 wherein the threshold selection criteria processing system is configured to detect runtime selection criteria values and further comprising:
a data store interaction system configured to identify one of the plurality of peak threshold values, as an identified peak threshold value, based on the runtime threshold selection criteria; and
an impact detection system configured to detect grain strikes based on the identified peak threshold value.

18. The agricultural system of claim 13 and further comprising:
a time threshold detection system configured to generate a time threshold value based on a set of time threshold criteria, wherein the impact sensor signal processing system is configured to receive the sensor signal from the agricultural impact sensor and detect grain strikes indicated by the sensor signal based on the time threshold value.

19. An agricultural system, comprising:
a signal aggregation system configured to aggregate a set of sensor signal values generated by an agricultural impact sensor on an agricultural harvester;
an inflection point identification system configured to sort the sensor signal values based on magnitude to obtain sorted sensor signal values and to identify an inflection point in the sorted sensor signal values;
a peak threshold identifier configured to generate a peak threshold value based on the inflection point; and
a threshold output system configured to generate a peak threshold output indicative of the peak threshold value.

20. The agricultural system of claim 19 and further comprising:
an impact sensor signal processing system configured to detect grain strikes based on the peak threshold value.
